(19) United States
(12) Patent Application Publication
(10) Pub. No.: US 2021/0365919 A1
(43) Pub. Date: Nov. 25, 2021

(54) METHOD AND APPARATUS FOR IMPLEMENTING A PAYMENT OPTIMIZER APPLICATION MODULE

(71) Applicant: JPMorgan Chase Bank, N.A., New York, NY (US)

(72) Inventors: Praveen KUMAR, Palghar (IN); Christopher RAMSAY, Brockport, NY (US); Shashin DALAL, Mumbai (IN); Jacob Allen OLINS, Chicago, IL (US); Amit Ramraj SINGH, Palghar (IN); Vivek B. SHAH, Mumbai (IN); Abhilash RAO, Mumbai (IN)

(73) Assignee: JPMorgan Chase Bank, N.A., New York, NY (US)

(21) Appl. No.: 17/325,735

(22) Filed: May 20, 2021

Related U.S. Application Data
(60) Provisional application No. 63/028,045, filed on May 21, 2020.

(51) Int. Cl. G06Q 20/24

(52) U.S. Cl. CPC G06Q 20/24

(57) ABSTRACT

Various methods, apparatuses/systems, and media for implementing a payment optimizer application module are disclosed. A supplier system accepts a predefined fixed net payment term for all participating buyers on a network. A processor determines weighted average cost of capital (WACC) data of buyer key data points from buyer audited statements data corresponding to a payment file data and WACC data of supplier key data points from supplier audited statements data corresponding to the payment file data. The processor also determines an optimal disbursement date of payment over the predefined fixed net payment term based on the WACC data; applies the stored set of payment rules to determine an optimal payment method corresponding to the WACC data; and automatically executes disbursement of a payment to the supplier in accordance with the optimal disbursement date based on the optimal payment method.

### CROSS-REFERENCE TO RELATED APPLICATIONS

This application claims the benefit of priority from U.S. Provisional Patent Application No. 63/028,045, filed May 21, 2020, which is herein incorporated by reference in its entirety.

### TECHNICAL FIELD

This disclosure generally relates to payment optimization, and, more particularly, to methods and apparatuses for implementing a payment optimizer application module for applying an algorithm to automatically determine the most mutually beneficial payment day between an individual buyer and an individual supplier based on a fixed net payment term.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Current payment monetization solutions are typically supplier funded (e.g., suppliers pay a fee to receive payments and the fee is revenue-shared between the solution provider and the buyer). Inflexible solutions with fixed methods and costs of payment are often imposed on suppliers by buyers and their solution providers. Non-strategic suppliers may be forced to opt-in to the buyer's preferred method of payment and absorb its cost, or opt-out and potentially face punitive payment terms. The timing of these payments may often be controlled entirely by the buyer and may be dependent on the speed of their invoice-approval process. Real-time working capital and liquidity needs of individual suppliers may not be solved for, and as a result, most solutions may fail to monetize more than 10% of vendor payables spend.

Also, traditionally, the discounting offering (static or dynamic) in Payables/Receivables is between a payer and a payee. The payer may approve or reject the discount offers made by the payee. Payee may have lesser control over their working capital and their receivables, thereby often increasing their Days Sales Outstanding (DSO) which is a measure of the average number of days that it takes the payee to collect payment after a sale has been made. DSO.

### SUMMARY

The present disclosure, through one or more of its various aspects, embodiments, and/or specific features or sub-components, may provide, among others, various systems, servers, devices, methods, media, programs, and platforms for implementing a payment optimizer application module for applying an algorithm to automatically determine the most mutually beneficial payment day between an individual buyer and an individual supplier based on a fixed net payment term, but the disclosure is not limited thereto. The present disclosure, through one or more of its various aspects, embodiments, and/or specific features or sub-components, may provide, among others, various systems, servers, devices, methods, media, programs, and platforms for implementing a payment optimizer application module that may automatically determine the optimal buyer and supplier financial return based on weighted average cost of capital (WACC) for each payment within the parameters set by the supplier at the time of their enrollment on the network, but the disclosure is not limited thereto. According to exemplary embodiments, the variables required for the algorithm utilized by the WACC-based payment optimizer application module may be the WACC for both the buyer data and the supplier data, the net payment term data, and the amount of the payment data, but the disclosure is not limited thereto.

The present disclosure, through one or more of its various aspects, embodiments, and/or specific features or sub-components, may provide, among others, various systems, servers, devices, methods, media, programs, and platforms for implementing a payment optimizer application module for applying an algorithm (e.g., set of rules) in real-time to optimize payments and monitor each outcome.

According to an aspect of the present disclosure, a method for implementing a payment optimizer application module by utilizing one or more processors and one or more memories is disclosed. The method may include: providing a database that stores buyer profile data, supplier profile data, payment file data, and a set of payment rules; accepting a predefined fixed net payment term for all participating buyers on a network; receiving key data points from buyer audited statements data corresponding to the payment file data to determine weighted average cost of capital (WACC) data of the buyer key data points; receiving key data points from supplier audited statements data to determine WACC data of the supplier key data points; determining an optimal disbursement date of payment over the predefined fixed net payment term based on the determined WACC data of the buyer key data points and the determined WACC data of the supplier key data points; applying the stored set of payment rules to determine an optimal payment method corresponding to the WACC data; and automatically executing disbursement of a payment to the supplier in accordance with the optimal disbursement date based on the optimal payment method.

According to another aspect of the present disclosure, wherein determining an optimal disbursement date of payment may further include: receiving data corresponding to a buyer time-value of money (TVM) based on the key data points of the buyer audited statements corresponding to the payment file data; receiving data corresponding to a supplier TVM based on the supplier audited statements corresponding to the payment file data; and determining the optimal disbursement date based on a value where the buyer TVM and the supplier TVM is equal.

According to yet another aspect of the present disclosure, wherein determining an optimal disbursement date of payment may further include: generating a first line graph corresponding to a buyer time-value of money (TVM) based on the key data points of the buyer audited statements corresponding to the payment file data; generating a second line graph corresponding to a supplier TVM based on the supplier audited statements corresponding to the payment file data; and setting a cross point of the first and second line graphs as the optimal disbursement date of payment.

According to further aspect of the present disclosure, wherein the payment file data may include one or more of the following data, but the disclosure is not limited thereto: payable amount, remittance address, supplier name and unique identifier, and remittance information including invoice date and invoice amount.

According to yet another aspect of the present disclosure, wherein the buyer profile data may include one or more of the following data, but the disclosure is not limited thereto: WACC data of the buyer key data points, buyer name and unique identifier, operating account, and standard term.

According to an additional aspect of the present disclosure, wherein the supplier profile data may include one or more of the following data, but the disclosure is not limited thereto: WACC data of the supplier key data points, supplier name and unique identifier, single-use account (SUA), fixed discount parameters, and remittance address.

According to yet another aspect of the present disclosure, wherein the optimal payment method may include any one of the following method of payment, but the disclosure is not limited thereto: single-use account (SUA), automated clearing house (ACH), wire transfer, check, and real-time payment (RTP).

According to another aspect of the present disclosure, a system for implementing a payment optimizer application module is disclosed. The system may include a database including memories that store buyer profile data, supplier profile data, payment file data, and a set of payment rules and a processor that is coupled to the database via a communication network. The processor may be configured to: accept a predefined fixed net payment term for all participating buyers on a network; receive key data points from buyer audited statements data corresponding to the payment file data to determine weighted average cost of capital (WACC) data of the buyer key data points; receive key data points from supplier audited statements data to determine WACC data of the supplier key data points; determine an optimal disbursement date of payment over the predefined fixed net payment term based on the determined WACC data of the buyer key data points and the determined WACC data of the supplier key data points; apply the stored set of payment rules to determine an optimal payment method corresponding to the WACC data; and automatically execute disbursement of a payment to the supplier in accordance with the optimal disbursement date based on the optimal payment method.

According to yet another aspect of the present disclosure, wherein, in determining an optimal disbursement date of payment, the processor may be further configured to: receive data corresponding to a buyer time-value of money (TVM) based on the key data points of the buyer audited statements corresponding to the payment file data; receive data corresponding to a supplier TVM based on the supplier audited statements corresponding to the payment file data; and determine the optimal disbursement date based on a value where the buyer TVM and the supplier TVM is equal.

According to an additional aspect of the present disclosure, wherein, in determining an optimal disbursement date of payment, the processor may be further configured to: generate a first line graph corresponding to a buyer time-value of money (TVM) based on the key data points of the buyer audited statements corresponding to the payment file data; generate a second line graph corresponding to a supplier TVM based on the supplier audited statements corresponding to the payment file data; and set a cross point of the first and second line graphs as the optimal disbursement date of payment.

According to a further aspect of the present disclosure, a non-transitory computer readable medium configured to store instructions for implementing a payment optimizer application module is disclosed. The instructions, when executed, may cause a processor to perform the following: accessing a database that stores buyer profile data, supplier profile data, payment file data, and a set of payment rules; accepting a predefined fixed net payment term for all participating buyers on a network; receiving key data points from buyer audited statements data corresponding to the payment file data to determine weighted average cost of capital (WACC) data of the buyer key data points; receiving key data points from supplier audited statements data to determine WACC data of the supplier key data points; determining an optimal disbursement date of payment over the predefined fixed net payment term based on the determined WACC data of the buyer key data points and the determined WACC data of the supplier key data points; applying the stored set of payment rules to determine an optimal payment method corresponding to the WACC data; and automatically executing disbursement of a payment to the supplier in accordance with the optimal disbursement date based on the optimal payment method.

According to another aspect of the present disclosure, wherein in determining an optimal disbursement date of payment, the instructions, when executed, may further cause the processor to perform the following: receiving data corresponding to a buyer time-value of money (TVM) based on the key data points of the buyer audited statements corresponding to the payment file data; receiving data corresponding to a supplier TVM based on the supplier audited statements corresponding to the payment file data; and determining the optimal disbursement date based on a value where the buyer TVM and the supplier TVM is equal.

According to yet another aspect of the present disclosure, wherein in determining an optimal disbursement date of payment, the instructions, when executed, may further cause the processor to perform the following: generating a first line graph corresponding to a buyer time-value of money (TVM) based on the key data points of the buyer audited statements corresponding to the payment file data; generating a second line graph corresponding to a supplier TVM based on the supplier audited statements corresponding to the payment file data; and setting a cross point of the first and second line graphs as the optimal disbursement date of payment.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a payment optimizer application module in accordance with an exemplary embodiment.

FIG. 2 illustrates an exemplary network diagram of a payment optimizer application device in accordance with an exemplary embodiment.

FIG. 3 illustrates a system diagram for implementing a payment optimizer application device with a payment optimizer application module in accordance with an exemplary embodiment.

FIG. 4 illustrates a system diagram for implementing a payment optimizer application module of FIG. 3 in accordance with an exemplary embodiment.

FIG. 5 illustrates an exemplary buyer's liquidity structure in accordance with an exemplary embodiment.

FIG. 6 illustrates an exemplary portal for payment optimizer in accordance with an exemplary embodiment.

FIG. 7 illustrates a graphical representation of an exemplary optimized disbursement date in accordance with an exemplary embodiment.

FIG. 7A illustrates another graphical representation of an exemplary optimized disbursement date in accordance with an exemplary embodiment.

FIG. 8 illustrates an exemplary table of a decision tree and a decision action in accordance with an exemplary embodiment.

FIG. 9 illustrates a flow chart for implementing a payment optimizer application module in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units, engines, tools, devices and/or modules. Those skilled in the art will appreciate that these blocks, units, engines, tools, devices, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, engines, tools, devices, and/or modules being implemented by microprocessors or similar, they may be programmed using software (e.g., microcode) to perform various functions discussed herein and may optionally be driven by firmware and/or software. Alternatively, each block, unit, engine, tool device, and/or module may be implemented by dedicated hardware, or as a combination of dedicated hardware to perform some functions and a processor (e.g., one or more programmed microprocessors and associated circuitry) to perform other functions. Also, each block, unit, engine, tool, device, and/or module of the example embodiments may be physically separated into two or more interacting and discrete blocks, units, engines, tools, devices, and/or modules without departing from the scope of the inventive concepts. Further, the blocks, units, engines, tools, devices, and/or modules of the example embodiments may be physically combined into more complex blocks, units, engines, tools, devices, and/or modules without departing from the scope of the present disclosure.

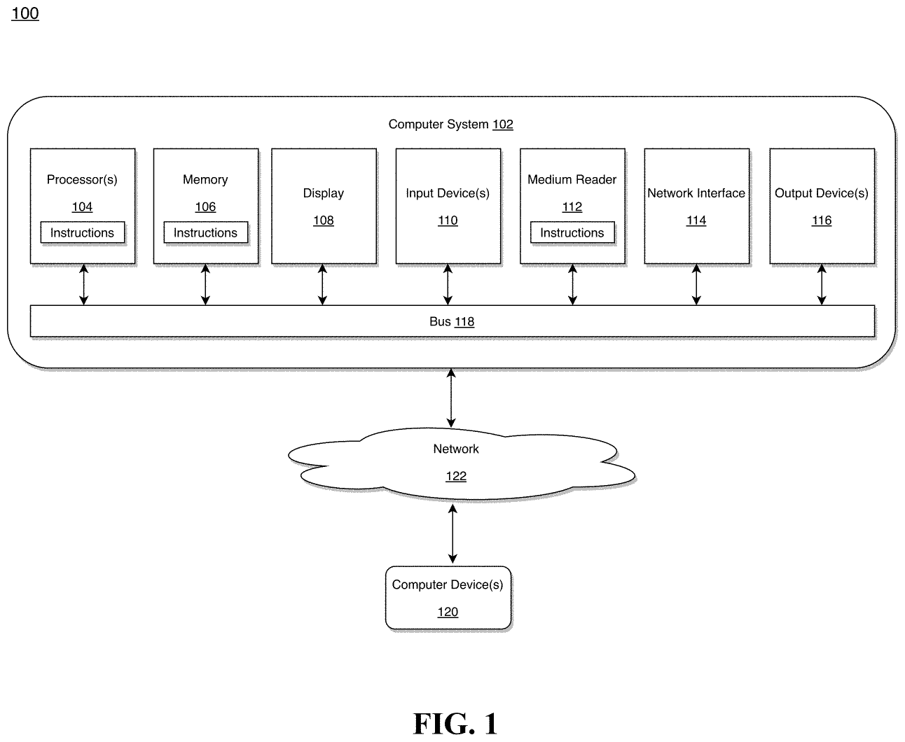

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 maybe, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of implementing a payment optimizer application module for applying an algorithm to automatically determine the most mutually beneficial payment day between an individual buyer and an individual supplier based on a fixed net payment term, but the disclosure is not limited thereto.

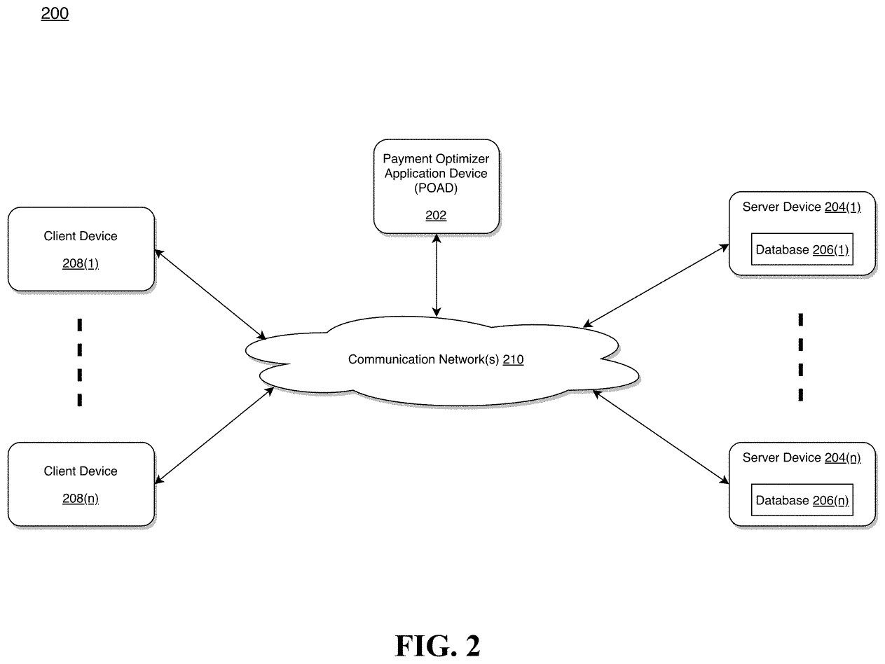

Referring to FIG. 2, a schematic of an exemplary network environment 200 for implementing a payment optimizer application device (POAD) of the instant disclosure is illustrated.

Conventional system, that does not implement a POAD of the instant disclosure, may not be able to process real-time working capital and liquidity needs of individual suppliers, and as a result, most solutions may fail to monetize more than 10% of vendor payables spend.

According to exemplary embodiments, the above-described problems associated with conventional system may be overcome by implementing a POAD 202 having a payment optimization application module as illustrated in FIG. 2 to automatically determine the most mutually beneficial payment day between an individual buyer and an individual supplier based on a fixed net payment term, but the disclosure is not limited thereto. According to exemplary embodiments, the above-described problems associated with conventional system may be overcome by implementing a POAD 202 having a payment optimization application module as illustrated in FIG. 2 to automatically determine the optimal buyer and supplier financial return based on weighted average cost of capital (WACC) for each payment within the parameters set by the supplier at the time of their enrollment on the network, but the disclosure is not limited thereto.

The POAD 202 may be the same or similar to the computer system 102 as described with respect to FIG. 1.

The POAD 202 may store one or more applications that can include executable instructions that, when executed by the POAD 202, cause the POAD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the POAD 202 itself, may be located in virtual server(s) running in a cloud-based computing environment rather than being tied to one or more specific physical network computing devices. Also, the application(s) may be running in one or more virtual machines (VMs) executing on the POAD 202. Additionally, in one or more embodiments of this technology, virtual machine(s) running on the POAD 202 may be managed or supervised by a hypervisor.

In the network environment 200 of FIG. 2, the POAD 202 is coupled to a plurality of server devices 204(1)-204(n) that hosts a plurality of databases 206(1)-206(n), and also to a plurality of client devices 208(1)-208(n) via communication network(s) 210. A communication interface of the POAD 202, such as the network interface 114 of the computer system 102 of FIG. 1, operatively couples and communicates between the POAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the POAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The POAD 202 may be a standalone device or integrated with one or more other devices or apparatuses, such as one or more of the server devices 204(1)-204(n), for example. In one particular example, the POAD 202 may be hosted by one of the server devices 204(1)-204(n), and other arrangements are also possible. Moreover, one or more of the devices of the POAD 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the POAD 202 via the communication network(s) 210 according to the HTTP-based and/or JavaScript Object Notation (JSON) protocol, for example, although other protocols may also be used.

The server devices 204(1)-204(n) maybe hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the POAD 202 that may be configured for automatically collating data from multiple different source systems into one self-service dashboard, thereby significantly improving release management process and reducing release time, but the disclosure is not limited thereto.

Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the POAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the POAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the POAD 202, the server devices 204(1)-204(n), or the client devices 208(1)-208(n), for example, may be configured to operate as virtual instances on the same physical machine. For example, one or more of the POAD 202, the server devices 204(1)-204(n), or the client devices 208(1)-208(n) may operate on the same physical device rather than as separate devices communicating through communication network(s) 210. Additionally, there may be more or fewer POADs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

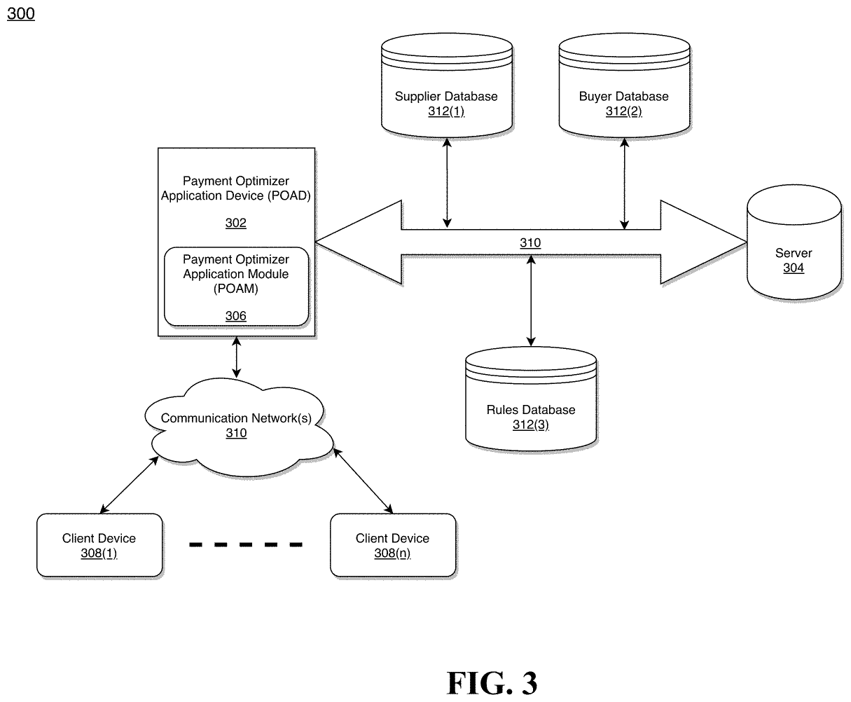

FIG. 3 illustrates a system diagram for implementing a POAD with a payment optimizer application module (POAM) in accordance with an exemplary embodiment.

As illustrated in FIG. 3, in the system 300, according to exemplary embodiments, the POAD 302 including the POAM 306 may be connected to a server 304, a supplier database 312(1), a buyer database 312(2), and a rules database 312(3) via a communication network 310, but the disclosure is not limited thereto. For example, according to exemplary embodiments, the POAM 306 may be connected to any desired database besides the supplier database 312(1), the buyer database 312(2), and the rules database 312(3).

According to exemplary embodiments, the supplier database 312(1) may be configured to store supplier profile data including one or more of the following data: weighted average cost of capital (WACC) data of the supplier key data points, supplier name and unique identifier, single-use account (SUA), fixed discount parameters, and remittance address, but the disclosure is not limited thereto. The buyer database 312(2) may be configured to store buyer profile data including one or more of the following data: WACC data of the buyer key data points, buyer name and unique identifier, operating account, and standard term, but the disclosure is not limited thereto. The rules database 312(3) may be configured to store a set of predefined payment rules for disbursement of a payment, but the disclosure is not limited thereto. For example, the rules database 312(3) may also be configured to store a payment file data that may include one or more of the following data: payable amount, remittance address, supplier name and unique identifier, and remittance information including invoice date and invoice amount, but the disclosure is not limited thereto.

Although FIG. 3 illustrates the supplier database 312(1), the buyer database 312(2), and the rules database 312(3) as being separate databases, according to exemplary embodiments, these three databases may be configured to be combined as one single database for storing data stored in these databases.

According to exemplary embodiment, the POAD 302 is described and shown in FIG. 3 as including the POAM 306, although it may include other rules, policies, modules, databases, or applications, for example. According to exemplary embodiments, the supplier database 312(1), the buyer database 312(2), and the rules database 312(3) may be embedded within the POAD 302. According to exemplary embodiments, the server 304 may also be a database which may be configured to store information including the metadata, but the disclosure is not limited thereto. According to exemplary embodiments, the POAM 306 may also be referred to as a processor.

According to exemplary embodiments, the POAM 306 may be configured to receive continuous feed of data from the server 304, the supplier database 312(1), the buyer database 312(2), and the rules database 312(3) via the communication network 310. According to exemplary embodiments, the POAM 306 may also be configured to communicate with the client devices 308(1)-308(n) (e.g., user's devices) via the communication network 310, but the disclosure is not limited thereto. According to exemplary embodiments, the client devices 308(1)-308(n) may also be referred to as buyer systems and/or supplier systems.

According to exemplary embodiments, artificial intelligence/Machine learning (AI/ML) models may be trained using CPUs and GPUs for tracking buyer's and or supplier's activities over the network, and automatically executing payment and working capital optimization recommendations at the communication network 310, relationship and/or transaction level based on previous activity and other macro data points like WACC, cost of borrowing, investment returns, etc., but the disclosure is not limited thereto.

As will be described below, the POAM 306 may be configured to accept a predefined fixed net payment term for all participating buyers on a network; determine WACC data of buyer key data points from buyer audited statements data corresponding to a payment file data and WACC data of supplier key data points from supplier audited statements data corresponding to the payment file data; determine an optimal disbursement date of payment over the predefined fixed net payment term based on the WACC data; apply the stored set of payment rules to determine an optimal payment method corresponding to the WACC data; and automatically execute disbursement of a payment to the supplier in accordance with the optimal disbursement date based on the optimal payment method.

According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the client devices 308(1)-308(n) may communicate with the POAD 302 via broadband or cellular communication. Of course, these embodiments are merely exemplary and are not limiting or exhaustive.

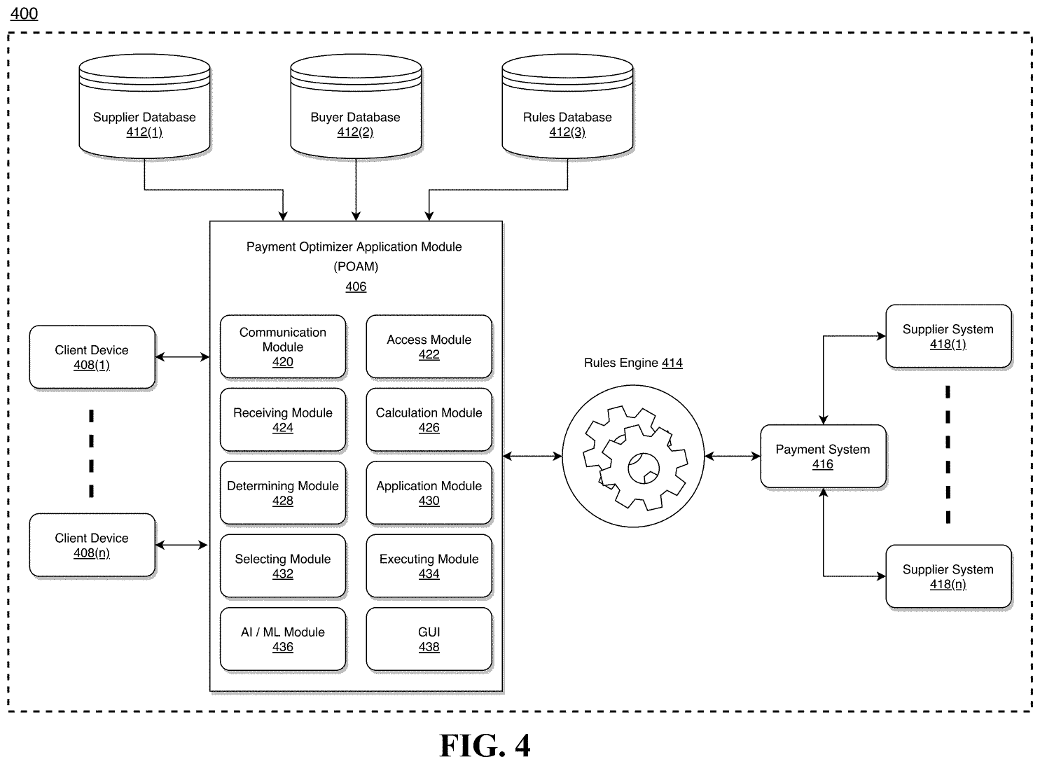

FIG. 4 illustrates a system diagram for implementing a payment optimizer application module (POAM) of FIG. 3 in accordance with an exemplary embodiment. As illustrated in FIG. 4, the system 400 may include an POAM 406, client devices 408(1)-408(n), a supplier database 412(1), a buyer database 412(2), a rules database 412(3), a rules engine 414, a payment system 416, supplier systems 418(1)-418(n), a server (not shown), and a communication network (not shown).

According to exemplary embodiments, the client devices 408(1)-408(n) may be same or similar to the client devices 308(1)-308(n) as illustrated in FIG. 3; the supplier database 412(1) may be same or similar to the supplier database 312(1) as illustrated in FIG. 3; the buyer database 412(2) may be same or similar to the buyer database 312(2) as illustrated in FIG. 3; the rules database 412(3) may be same or similar to the rules database 312(3) as illustrated in FIG. 3. Further, the server (not shown) with reference to FIG. 4 may be same or similar to the server as illustrated in FIG. 3 and the communication network (not shown) with reference to FIG. 4 may be same or similar to the communication network 310.

As illustrated in FIG. 4, the POAM 406 may include a communication module 420, an access module 422, a receiving module 424, a calculation module 426, a determining module 428, an application module 430, a selecting module 432, an executing module 434, an AI/ML module 436, and a graphical user interface (GUI) 438. According to exemplary embodiments, the POAM 406 may include various systems that are managed and operated by an organization by utilizing user's device (e.g., client devices 408(1)-408(n), supplier systems 418(1)-418(n), and buyer systems (not shown)).

Referring to FIGS. 3 and 4, the process may be executed via the communication network 310 which may comprise plural networks as described above. For example, in an exemplary embodiment, the various components of the POAM 406 may communicate with the client devices 408(1)-408(n), the supplier database 412(1), the buyer database 412(2), the rules database 412(3), the rules engine 414, the payment system 416, the supplier systems 418(1)-418(n), the server 304, via the communication module 430 and the communication network 310. Of course, these embodiments are merely exemplary and are not limiting or exhaustive.

According to exemplary embodiments, each of the communication module 420, the access module 422, the receiving module 424, the calculation module 426, the determining module 428, the application module 430, the selecting module 432, the executing module 434, and the AI/ML module 436 may be implemented by microprocessors or similar, they may be programmed using software (e.g., microcode) to perform various functions discussed herein. Alternatively, each of the communication module 420, the access module 422, the receiving module 424, the calculation module 426, the determining module 428, the application module 430, the selecting module 432, the executing module 434, and the AI/ML module 436 may be implemented by dedicated hardware, or as a combination of dedicated hardware to perform some functions and a processor (e.g., one or more programmed microprocessors and associated circuitry) to perform various functions discussed herein as well as other functions. Also, according to exemplary embodiments, each of the communication module 420, the access module 422, the receiving module 424, the calculation module 426, the determining module 428, the application module 430, the selecting module 432, the executing module 434, and the AI/ML module 436 may be physically separated into two or more interacting and discrete blocks, units, engines, devices, and/or modules without departing from the scope of the inventive concepts.

According to exemplary embodiments, the communication module 420 establishes a link between the POAM 406 and the supplier systems 418(1)-418(n), the buyer systems (not shown), the client devices 408(1)-408(n), the supplier database 412(1), the buyer database 412(2), and the rules database 412(3) via the communication network 310. According to exemplary embodiments, the supplier database 412(1) may be configured to store supplier profile data including one or more of the following data: weighted average cost of capital (WACC) data of the supplier key data points, supplier name and unique identifier, single-use account (SUA), fixed discount parameters, and remittance address, but the disclosure is not limited thereto. The buyer database 412(2) may be configured to store buyer profile data including one or more of the following data: WACC data of the buyer key data points, buyer name and unique identifier, operating account, and standard term, but the disclosure is not limited thereto. The rules database 412(4) may be configured to store a set of predefined payment rules for disbursement of a payment, but the disclosure is not limited thereto. For example, the rules database 412(4) may also be configured to store a payment file data that may include one or more of the following data: payable amount, remittance address, supplier name and unique identifier, and remittance information including invoice date and invoice amount, but the disclosure is not limited thereto. The access module 422 may be configured to access the supplier database 412(1), the buyer database 412(2), and the rules database 412(3).

According to exemplary embodiments, the receiving module 424 may be configured to accept, from the supplier systems 418(1)-418(n), a predefined fixed net payment term for all participating buyers on the network.

According to exemplary embodiments, the receiving module 424 may be configured to receive key data points from buyer audited statements data corresponding to the payment file data accessed from the buyer database 412(2) and the rules database 412(3) to determine weighted average cost of capital (WACC) data of the buyer key data points.

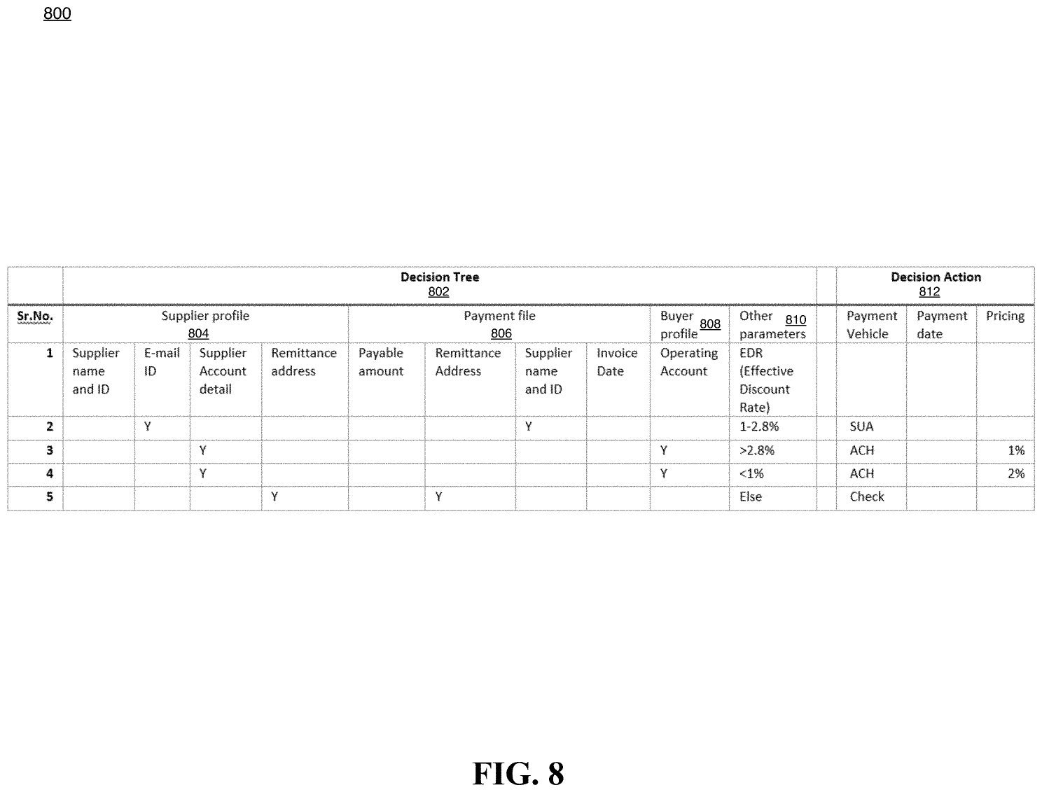

According to exemplary embodiments, the receiving module 424 may also be configured to receive key data points from supplier audited statements data corresponding to the payment file data accessed from the supplier database 412(1) and the rules database 412(3) to determine weighted average cost of capital (WACC) data of the supplier key data points. According to exemplary embodiments, the receiving module 424 may also be configured to receive data related to rules execution set that may include parameters and set of rules as decision tree where decision output would be payment vehicle (e.g., payment method, payment trail, etc.) and configurable pricing (see FIG. 8).

According to exemplary embodiments, the calculation module 426 may be configured to calculate exact buyer WACC data of the buyer key data points and the supplier WACC data of the supplier key data points.

According to exemplary embodiments, the determination module 428 may be configured to determine an optimal disbursement date of payment over the predefined fixed net payment term based on the determined WACC data of the buyer key data points and the determined WACC data of the supplier key data points. According to exemplary embodiments, the predefined fixed net payment term may be Net 90 (90 days payment term), but the disclosure is not limited thereto. For example, the predefined fixed net payment term may be Net 30 or Net 60 or any other mutually agreed payment term.

According to exemplary embodiments, the application module 430 may be configured to apply the stored set of payment rules accessed from the rules database 412(3) to determine an optimal payment method corresponding to the WACC data of the buyer key data points and the WACC data of the supplier key data points.

Rules engine 414, according to exemplary embodiments, may be configured to determine the optimal payment method based on the WACC data of the buyer key data points and the WACC data of the supplier key data points.

According to exemplary embodiments, the selecting module 432 may be configured to select the optimal payment method. The optimal payment method may include any one of the following method of payment: single-use account (SUA), automated clearing house (ACH), wire transfer, check, and real-time payment (RTP), but the disclosure is not limited thereto.

According to exemplary embodiments, the execution module 434 may be configured to automatically executing disbursement of a payment to the supplier in accordance with the optimal disbursement date determined by the determination module 428 based on the optimal payment method selected by the selecting module 432.

According to exemplary embodiments, in determining an optimal disbursement date of payment by the determining module 428, the POAM 406 may be configured in such that the receiving module 424 may be configured to receive data corresponding to a buyer time-value of money (TVM) based on the key data points of the buyer audited statements corresponding to the payment file data; receive data corresponding to a supplier TVM based on the supplier audited statements corresponding to the payment file data; and the determination module 428 may be configured to determine the optimal disbursement date based on a value where the buyer TVM and the supplier TVM is equal.

According to exemplary embodiments, in determining an optimal disbursement date of payment by the determining module 428, the POAM 406 may be configured in such that the calculation module 426 may be configured to generate a first line graph corresponding to a buyer time-value of money (TVM) based on the key data points of the buyer audited statements corresponding to the payment file data; generate a second line graph corresponding to a supplier TVM based on the supplier audited statements corresponding to the payment file data; and set a cross point of the first and second line graphs as the optimal disbursement date of payment.

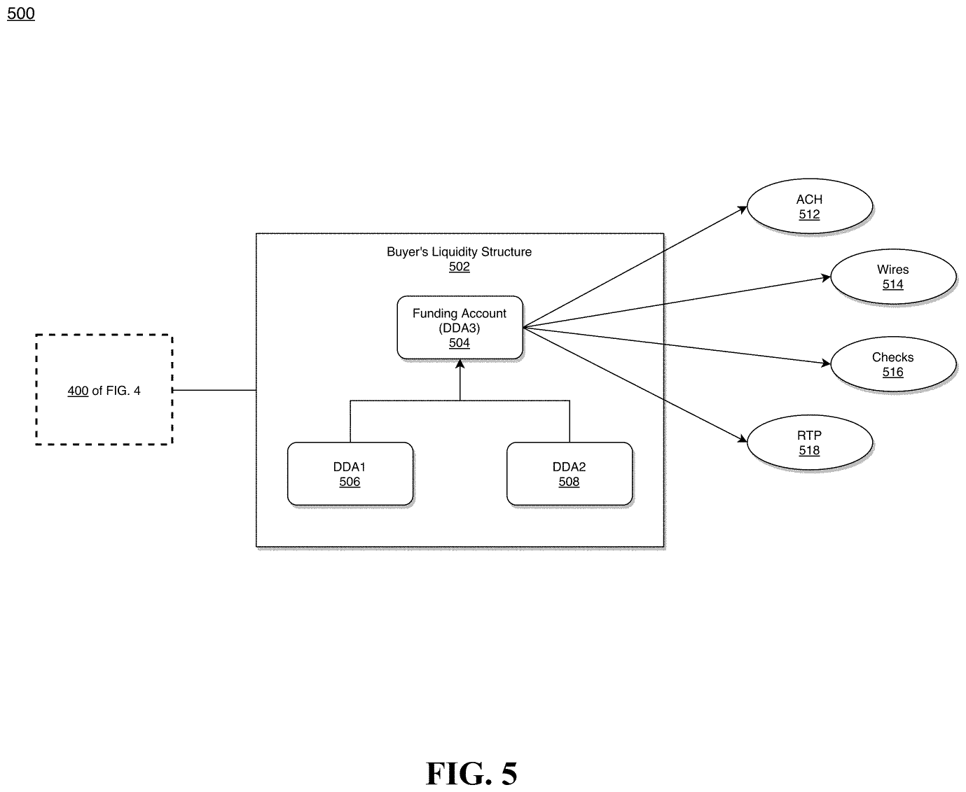

FIG. 5 illustrates a system 500 that illustrates an exemplary buyer's liquidity structure 502 that may be embedded within the system 400 of FIG. 4 in accordance with an exemplary embodiment. As illustrated in FIG. 5, the buyer's liquidity structure 502 may include a plurality of direct debit authorization (DDA), e.g., DDA1 506, DDA2 508, and DDA3 504. According to exemplary embodiments, client/buyer's payable DDA can be participated in the buyers' liquidity structure 502 (physical cash concentration or Notional pooling or JIT (just in time funding)) to fund this account as and when necessary, acting as a control disbursement account (CDA). As illustrated in FIG. 5, according to exemplary embodiments, the DDA3 504 is acting as the CDA and may apply any of the following payment method to disburse payment: ACH 512, wires 514, checks 516, RTP 518. The buyer's liquidity structure 502, according to exemplary embodiments, may ensure that only required fund would be available in DDA and the remaining can be utilized elsewhere to maximize buyer's working capital.

According to exemplary embodiments, the POAM 406 may be configured to be incorporated into a solution that leverages a pre-existing network of suppliers that are enrolled on a fixed net-term (i.e., Net 90). Buyers and Suppliers who participate provide key data points from their audited financial statements to determine their WACC. Suppliers who participate agree to a fixed net payment term of Net 90 (for example) for all participating buyers on the network. The WACC-based payment optimizer's algorithm utilized by the POAM 406 determines the mutually beneficial payment day (where buyer and supplier TVM is equal) over the net 90 payment term and transfers the payment from the buyer to the supplier 418(1)-418(n) via the payment rail identified by the rules engine 414. According to exemplary embodiments, the rules engine 414 may be a Drool's engine. For this solution as disclosed herein, the most flexible Drools, i.e., business rule management system (BRMS) may be implemented. According to exemplary embodiments, Drool decision making parameters may include the payment file data, buyer profile data, and the supplier profile data as disclosed herein (see FIG. 8).

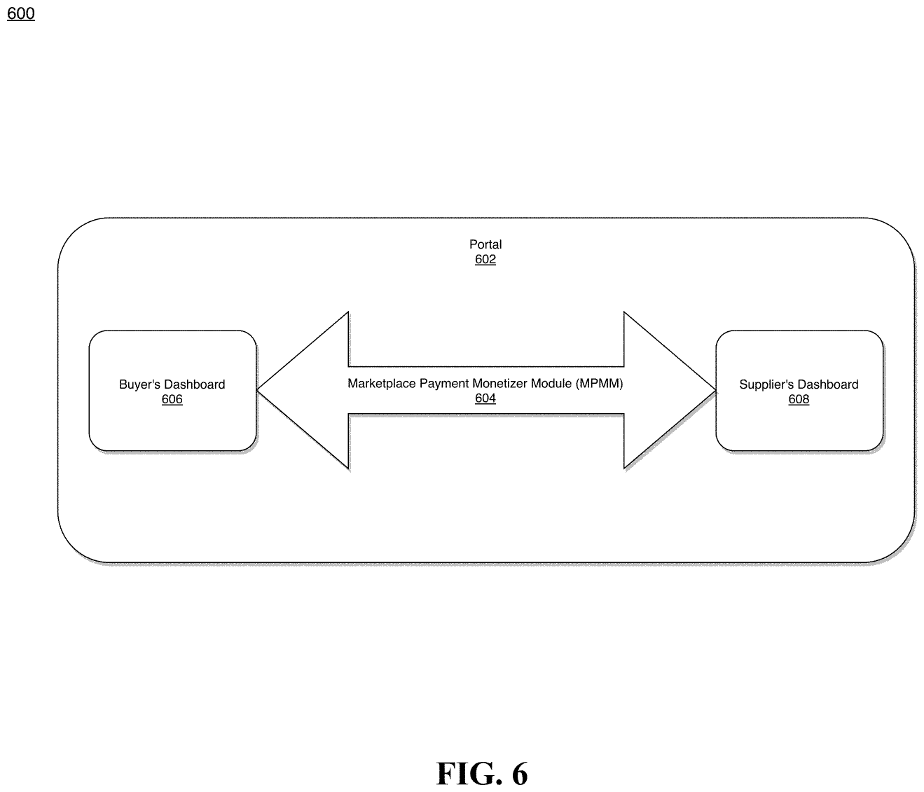

FIG. 6 illustrates an exemplary portal 602 for payment optimizer in accordance with an exemplary embodiment. As illustrated in FIG. 6, the portal 602 may include a marketplace payment monetizer module (MPMM) 604, a buyer's dashboard 606, and supplier's dashboard 608. The MPMM 604 may be the same or similar to the POAM 406 as illustrated in FIG. 4. According to exemplary embodiments, the portal 602 may be configured to provide a sophisticated solution where a buyer and a supplier can interact in the marketplace via the buyer's dashboard 606 and the supplier's dashboard 608. Thus, by utilizing the portal 602 of the instant disclosure, buyers and suppliers may have unlimited flexibility to make/accept offers on payment for a limited period or open ended offer; buyer and supplier may override a payment rail (oppose to derived from Drools engine); artificial intelligence running/machine learning on the top of this solution to record the overridden value, but the disclosure is not limited thereto.

Referring to FIGS. 3-6, as illustrated in FIG. 6, the WACC-based payment optimizer's algorithm implemented by the MPMM 604 may determine the most mutually beneficial payment day over the Net 90 payment term and may be set-up to transfer the payment from the buyer's system 308(1)-308(n) to the supplier system 418(1)-418(n) via the best payment rail (e.g., payment method) identified via the Drools engine for that day. According to this exemplary embodiment as illustrated in FIG. 6, the proposed solution builds upon the proposed solution as described with reference to FIG. 4, and further enables buyers and suppliers to coordinate, via proactive communication, the timing of payments to ensure each can meet their real-time working capital needs. Buyers and suppliers can initiate offers to accelerate or decelerate payments, which would be accompanied by an incentive for the other party to accept the offer on the initiating party's terms (examples; an early-payment discount, acceptance of a commercial card/SUA payment or a late-payment fee). According to exemplary embodiments, the portal 602 may allow buyers and suppliers to have unlimited flexibility to make/accept offers on individual, some or all payments on an ad-hoc basis or for a limited or open-ended period of time. Buyers and suppliers would interact in the marketplace via a dashboard that provide a real-time snapshot of the complete working capital value associated with all payables/receivable in play, factoring in WACC, cost and the subsequent impacts to working capital and liquidity from payment acceleration and deceleration.

Further, according to exemplary embodiments, the AI/ML module 436 may be incorporated into the MPMM 604 in order to track activity and make payment and working capital optimization recommendations at the network, relationship and/or transaction level based on previous activity and other macro data points like WACC, cost of borrowing, investment returns, etc., but the disclosure is not limited thereto.

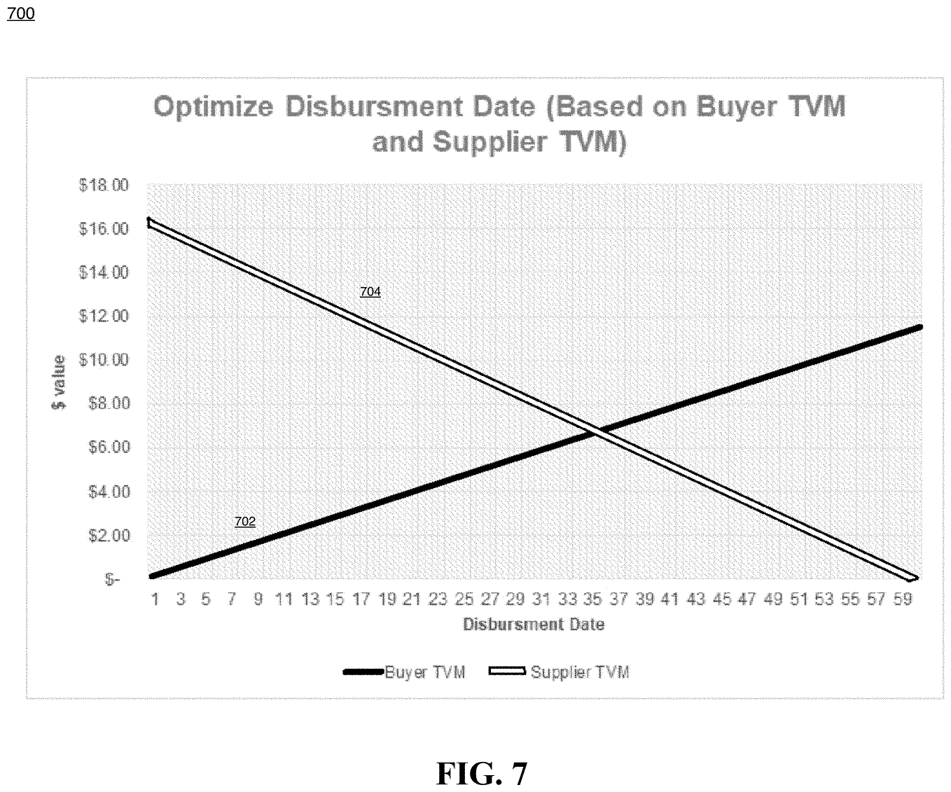

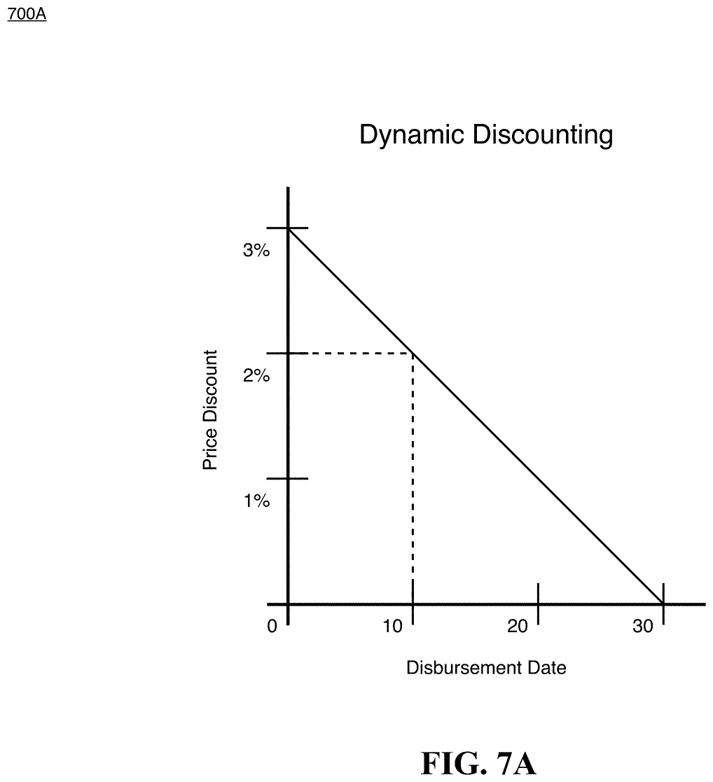

FIG. 7 illustrates a graphical representation of an exemplary optimized disbursement date in accordance with an exemplary embodiment. As illustrated in FIG. 7, the graph 700 onto the GUI 438 shows an optimized disbursement date based on buyer TVM and supplier TVM. The horizontal axis represents disbursement date and the vertical axis represents monetary value in U.S. dollars. As illustrated in this graph 700, the first line graph 702 corresponds to a buyer time-value of money (TVM) based on the key data points of the buyer audited statements corresponding to the payment file data and the second line graph 704 corresponds to a supplier TVM based on the supplier audited statements corresponding to the payment file data. The cross point of the first line graph 702 and the second line graph 704 is set to be the optimal disbursement date of payment (i.e., 36^{th} day of the Net 60 payment term).

According to exemplary embodiments, the MPMM 604 may be further configured to optimize payments through a set of rules applied in real-time and enable a payee and/or payer to monitor each outcome, but the disclosure is not limited thereto. For example, according to exemplary embodiments, the MPMM 604 may be configured to create a number of routing parameters that determine how a payment transaction may be processed. For example, the MPMM 604 may be configured to send transactions to the most cost-efficient payment rail, e.g., as illustrated with reference to FIGS. 4 and 5 above, thereby minimizing platform fees for every transaction.

According to exemplary embodiments, the MPMM 604 may be further configured to compile and present a time-based discount offer to the payment platform along with the optimal payment rail and to the platform profit/revenue for each discount offer and how it may invest to increase profit. The payment platform provided by the MPMM 604, according to exemplary embodiments, may present the discount offers to the payee for selection or apply the offer based on configured payee terms. Payee, who may avail the offer and choose the time of settlement, thereby resulting better control over the receivables and driving savings by choosing the settlement discount, but the disclosure is not limited thereto. Thus, according to exemplary embodiments, the MPMM 604 may be configured to allow payer and/or payee to better manage their working capital and DSO as per their needs.

FIG. 7A illustrates another graphical representation of an exemplary optimized disbursement date in accordance with an exemplary embodiment. As illustrated in FIG. 7A, the graph 700A represents a dynamic discounting chart that illustrates a time-based discount offer. For example, according to the dynamic discounting chart, if a payer selects an option by utilizing the MPMM 604 to pay by the 10^{th} date (disbursement date after issuance of an invoice), the payer will receive a 2% discount on the invoice. According to exemplary embodiments, by utilizing the MPMM 604, the payee may avail the offer an choose the time of settlement, thereby obtaining better control over the receivables and drive savings by choosing the settlement discount.

According to exemplary embodiments, all the payment platforms facilitating B2B payments may leverage the MPMM 604 to identify the optimum payment rail, get a time-based reduced/prorated discount offer for each payment, which may be presented to the payee and provide them the option to choose and gain greater control over their receivables. According to conventional techniques, either payee offering a discount to payer for early payment or leveraging supply chain financing or payer using a credit line to make early payment using cards and Payee bears the transaction cost. However, according to exemplary embodiments, the MPMM 604 may be configured to provide greater control in the hands of payee and provide them with a time-based reduced/prorated discount offer which may give them greater control over their receivables and better manage the cost.

FIG. 8 illustrates an exemplary table 800 of a decision tree and a decision action in accordance with an exemplary embodiment. As illustrated in FIG. 8, the table 800 illustrates a decision tree 802 that may include a column for serial number, a column for supplier profile 804, a column for payment file 806, a column for buyer profile 808, a column for other parameters 810, but the disclosure is not limited thereto. As illustrated in FIG. 8, the table 800 also illustrates a column a decision action 812 that may include a column for payment vehicle, a column for payment date, and a column for pricing, but the disclosure is not limited thereto.

As illustrated in FIG. 8, the column for supplier profile 804 may include a column for supplier name and unique identifier (ID), a column for E-mail ID of the supplier, and a column for remittance address, but the disclosure is not limited thereto. As illustrated in FIG. 8, the column for payment file 806 may include a column for payable amount, a column for remittance address, a column for supplier name and ID, a column for invoice date, but the disclosure is not limited thereto. As illustrated in FIG. 8, the column buyer profile 808 may include a column for operating account, but the disclosure is not limited thereto. As illustrated in FIG. 8, the column for other parameters 810 may include a column for effective discount rate (EDR).

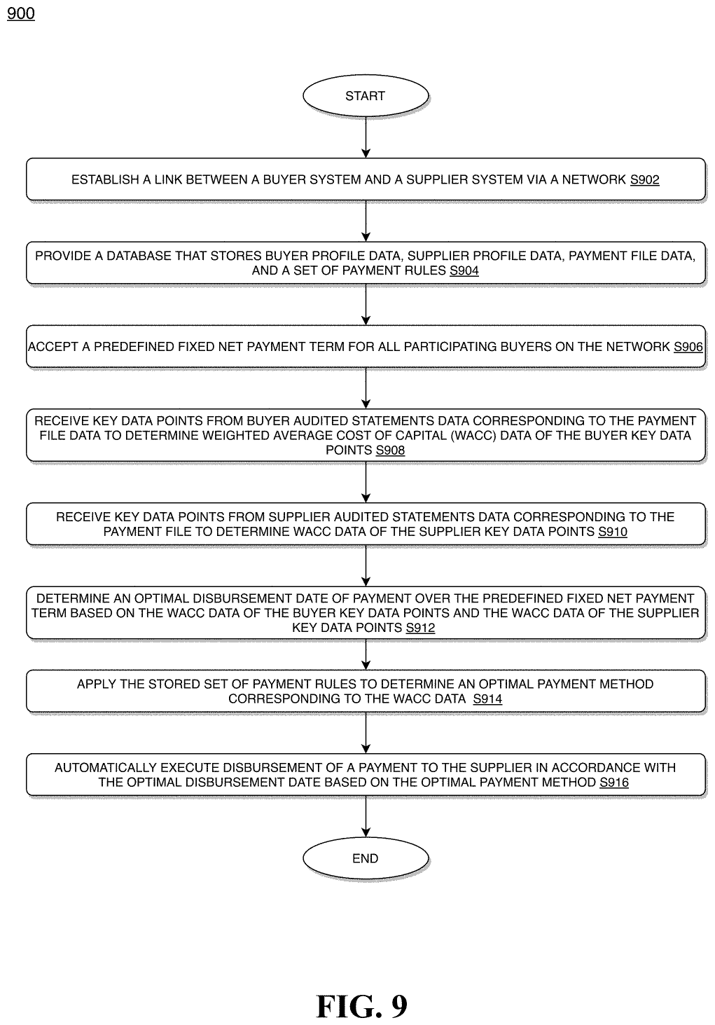

FIG. 9 illustrates a flow chart for implementing a payment optimizer application module in accordance with an exemplary embodiment.

It will be appreciated that the illustrated process 900 and associated steps may be performed in a different order, with illustrated steps omitted, with additional steps added, or with a combination of reordered, combined, omitted, or additional steps.

In the process 900 of FIG. 9, at step S902, a communication link may be established between a buyer system and a supplier system via a network.

At step S904, a database may be provided that stores buyer profile data, supplier profile data, payment file data, and a set of payment rules.

At step S906, a predefined fixed net payment term may be accepted from the buyer's system for all participating buyers on the network.

At step S908, key data points from buyer audited statements data corresponding to the payment file data may be received to determine weighted average cost of capital (WACC) data of the buyer key data points.

At step S910, key data points from supplier audited statements data corresponding to the payment file may be received to determine WACC data of the supplier key data points.

At step S912, an optimal disbursement date of payment over the predefined fixed net payment term may be determined based on the determined WACC data of the buyer key data points and the determined WACC data of the supplier key data points.

At step S914, the stored set of payment rules may be applied to determine an optimal payment method corresponding to the WACC data.

At step S916, disbursement of a payment may be automatically executed to the supplier in accordance with the optimal disbursement date based on the optimal payment method.

According to exemplary embodiments, the process 900 may further include: receiving data corresponding to a buyer time-value of money (TVM) based on the key data points of the buyer audited statements corresponding to the payment file data; receiving data corresponding to a supplier TVM based on the supplier audited statements corresponding to the payment file data; and determining the optimal disbursement date based on a value where the buyer TVM and the supplier TVM is equal.

According to exemplary embodiments, the process 900 may further include: generating a first line graph corresponding to a buyer time-value of money (TVM) based on the key data points of the buyer audited statements corresponding to the payment file data; generating a second line graph corresponding to a supplier TVM based on the supplier audited statements corresponding to the payment file data; and setting a cross point of the first and second line graphs as the optimal disbursement date of payment.

According to exemplary embodiments, a non-transitory computer readable medium may be configured to store instructions for implementing the POAM 406 or the MPMM 604 for automatically determining the most mutually beneficial payment day between an individual buyer and an individual supplier based on a fixed net payment term, but the disclosure is not limited thereto. According to exemplary embodiments, the instructions, when executed, may cause a processor embedded within the POAM 406 or the MPMM 604 to perform the following: accessing a database that stores buyer profile data, supplier profile data, payment file data, and a set of payment rules; accepting a predefined fixed net payment term for all participating buyers on a network; receiving key data points from buyer audited statements data corresponding to the payment file data to determine weighted average cost of capital (WACC) data of the buyer key data points; receiving key data points from supplier audited statements data to determine WACC data of the supplier key data points; determining an optimal disbursement date of payment over the predefined fixed net payment term based on the determined WACC data of the buyer key data points and the determined WACC data of the supplier key data points; applying the stored set of payment rules to determine an optimal payment method corresponding to the WACC data; and automatically executing disbursement of a payment to the supplier in accordance with the optimal disbursement date based on the optimal payment method. The processor may be the same or similar to the processor 104 as illustrated in FIG. 1 or the processor embedded within POAD 202, POAD 302, POAM 306, POAM 406, and MPMM 604.

According to exemplary embodiments, in determining an optimal disbursement date of payment, the instructions, when executed, may further cause the processor 104 to perform the following: receiving data corresponding to a buyer time-value of money (TVM) based on the key data points of the buyer audited statements corresponding to the payment file data; receiving data corresponding to a supplier TVM based on the supplier audited statements corresponding to the payment file data; and determining the optimal disbursement date based on a value where the buyer TVM and the supplier TVM is equal.

According to yet another aspect of the present disclosure, in determining an optimal disbursement date of payment, the instructions, when executed, may further cause the processor 104 to perform the following: generating a first line graph corresponding to a buyer time-value of money (TVM) based on the key data points of the buyer audited statements corresponding to the payment file data; generating a second line graph corresponding to a supplier TVM based on the supplier audited statements corresponding to the payment file data; and setting a cross point of the first and second line graphs as the optimal disbursement date of payment.

According to exemplary embodiments as disclosed above in FIGS. 1-9, technical improvements effected by the instant disclosure may include a platforms for implementing a payment optimizer application module for applying an algorithm to automatically determine the most mutually beneficial payment day between an individual buyer and an individual supplier based on a fixed net payment term, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for implementing a payment optimizer application module by utilizing one or more processors and one or more memories, the method comprising:
providing a database that stores buyer profile data, supplier profile data, payment file data, and a set of payment rules;
accepting a predefined fixed net payment term for all participating buyers on a network;
receiving key data points from buyer audited statements data corresponding to the payment file data to determine weighted average cost of capital (WACC) data of the buyer key data points;
receiving key data points from supplier audited statements data to determine WACC data of the supplier key data points;
determining an optimal disbursement date of payment over the predefined fixed net payment term based on the determined WACC data of the buyer key data points and the determined WACC data of the supplier key data points;
applying the stored set of payment rules to determine an optimal payment method corresponding to the WACC data; and
automatically executing disbursement of a payment to the supplier in accordance with the optimal disbursement date based on the optimal payment method.

2. The method according to claim 1, wherein determining an optimal disbursement date of payment comprises:
receiving data corresponding to a buyer time-value of money (TVM) based on the key data points of the buyer audited statements corresponding to the payment file data;
receiving data corresponding to a supplier TVM based on the supplier audited statements corresponding to the payment file data; and
determining the optimal disbursement date based on a value where the buyer TVM and the supplier TVM is equal.

3. The method according to claim 1, wherein determining an optimal disbursement date of payment comprises:
generating a first line graph corresponding to a buyer time-value of money (TVM) based on the key data points of the buyer audited statements corresponding to the payment file data;
generating a second line graph corresponding to a supplier TVM based on the supplier audited statements corresponding to the payment file data; and
setting a cross point of the first and second line graphs as the optimal disbursement date of payment.

4. The method according to claim 1, wherein the payment file data includes one or more of the following data: payable amount, remittance address, supplier name and unique identifier, and remittance information including invoice date and invoice amount.

5. The method according to claim 1, wherein the buyer profile data includes one or more of the following data: WACC data of the buyer key data points, buyer name and unique identifier, operating account, and standard term.

6. The method according to claim 1, wherein the supplier profile data includes one or more of the following data: WACC data of the supplier key data points, supplier name and unique identifier, single-use account (SUA), fixed discount parameters, and remittance address.

7. The method according to claim 1, wherein the optimal payment method includes any one of the following method of payment: single-use account (SUA), automated clearing house (ACH), wire transfer, check, and real-time payment (RTP).

8. A system for implementing a payment optimizer application module, comprising:
a database including memories that store buyer profile data, supplier profile data, payment file data, and a set of payment rules; and
a processor operatively connected to the database via a communication network, wherein the processor is configured to:
accept a predefined fixed net payment term for all participating buyers on a network;
receive key data points from buyer audited statements data corresponding to the payment file data to determine weighted average cost of capital (WACC) data of the buyer key data points;
receive key data points from supplier audited statements data to determine WACC data of the supplier key data points;
determine an optimal disbursement date of payment over the predefined fixed net payment term based on the determined WACC data of the buyer key data points and the determined WACC data of the supplier key data points;
apply the stored set of payment rules to determine an optimal payment method corresponding to the WACC data; and
automatically execute disbursement of a payment to the supplier in accordance with the optimal disbursement date based on the optimal payment method.

9. The system according to claim 8, wherein, in determining an optimal disbursement date of payment, the processor is further configured to:
receive data corresponding to a buyer time-value of money (TVM) based on the key data points of the buyer audited statements corresponding to the payment file data;
receive data corresponding to a supplier TVM based on the supplier audited statements corresponding to the payment file data; and
determine the optimal disbursement date based on a value where the buyer TVM and the supplier TVM is equal.

10. The system according to claim 8, wherein, in determining an optimal disbursement date of payment, the processor is further configured to:
generate a first line graph corresponding to a buyer time-value of money (TVM) based on the key data points of the buyer audited statements corresponding to the payment file data;
generate a second line graph corresponding to a supplier TVM based on the supplier audited statements corresponding to the payment file data; and
set a cross point of the first and second line graphs as the optimal disbursement date of payment.

11. The system according to claim 8, wherein the payment file data includes one or more of the following data: payable amount, remittance address, supplier name and unique identifier, and remittance information including invoice date and invoice amount.

12. The system according to claim 8, wherein the buyer profile data includes one or more of the following data: WACC data of the buyer key data points, buyer name and unique identifier, operating account, and standard term.

13. The system according to claim 8, wherein the supplier profile data includes one or more of the following data: WACC data of the supplier key data points, supplier name and unique identifier, single-use account (SUA), fixed discount parameters, and remittance address.

14. A non-transitory computer readable medium configured to store instructions for implementing a payment optimizer application module, wherein, when executed, the instructions cause a processor to perform the following:
accessing a database that stores buyer profile data, supplier profile data, payment file data, and a set of payment rules;
accepting a predefined fixed net payment term for all participating buyers on a network;
receiving key data points from buyer audited statements data corresponding to the payment file data to determine weighted average cost of capital (WACC) data of the buyer key data points;
receiving key data points from supplier audited statements data to determine WACC data of the supplier key data points;
determining an optimal disbursement date of payment over the predefined fixed net payment term based on the determined WACC data of the buyer key data points and the determined WACC data of the supplier key data points;
applying the stored set of payment rules to determine an optimal payment method corresponding to the WACC data; and
automatically executing disbursement of a payment to the supplier in accordance with the optimal disbursement date based on the optimal payment method.

15. The non-transitory computer readable medium according to claim 14, wherein, in determining an optimal disbursement date of payment, the instructions, when executed, cause the processor to further perform the following:
receiving data corresponding to a buyer time-value of money (TVM) based on the key data points of the buyer audited statements corresponding to the payment file data;
receiving data corresponding to a supplier TVM based on the supplier audited statements corresponding to the payment file data; and
determining the optimal disbursement date based on a value where the buyer TVM and the supplier TVM is equal.

16. The non-transitory computer readable medium according to claim 14, wherein, in determining an optimal disbursement date of payment, the instructions, when executed, cause the processor to further perform the following:
generating a first line graph corresponding to a buyer time-value of money (TVM) based on the key data points of the buyer audited statements corresponding to the payment file data;
generating a second line graph corresponding to a supplier TVM based on the supplier audited statements corresponding to the payment file data; and
setting a cross point of the first and second line graphs as the optimal disbursement date of payment.

17. The non-transitory computer readable medium according to claim 14, wherein the payment file data includes one or more of the following data: payable amount, remittance address, supplier name and unique identifier, and remittance information including invoice date and invoice amount.

18. The non-transitory computer readable medium according to claim 14, wherein the buyer profile data includes one or more of the following data: WACC data of the buyer key data points, buyer name and unique identifier, operating account, and standard term.

19. The non-transitory computer readable medium according to claim 14, wherein the supplier profile data includes one or more of the following data: WACC data of the supplier key data points, supplier name and unique identifier, single-use account (SUA), fixed discount parameters, and remittance address.

20. The non-transitory computer readable medium according to claim 14, wherein the optimal payment method includes any one of the following method of payment: single-use account (SUA), automated clearing house (ACH), wire transfer, check, and real-time payment (RTP).
